(19) United States
(12) Patent Application Publication
(10) Pub. No.: US 2020/0136697 A1
(43) Pub. Date: Apr. 30, 2020

(54) CS-BASED OMNIDIRECTIONAL BEAMFORMING DESIGN METHOD IN UNIFORM RECTANGULAR ARRAYS

(71) Applicant: FUDAN UNIVERSITY, Shanghai (CN)

(72) Inventors: Yi JIANG, Shanghai (CN); Dongliang SU, Shanghai (CN); Xin WANG, Shanghai (CN)

(21) Appl. No.: 16/659,439

(22) Filed: Oct. 21, 2019

(30) Foreign Application Priority Data
Oct. 27, 2018 (CN) 201811262310.5

(51) Int. Cl. H04B 7/06; H04B 7/0456; H04B 17/336

(52) U.S. Cl. CPC H04B 7/0617; H04B 17/336; H04B 7/0456

(57) ABSTRACT

The present invention belongs to the technical field of common signal transmission, and specifically relates to a CS-based omnidirectional beamforming design method in a uniform rectangular array. The main purpose of the present invention is to handle the beamforming design for realizing cell-level coverage in downlink transmission of common signals. For a large-size antenna base station with a uniform rectangular array, the present invention provides two omnidirectional beamforming design schemes: beamforming design based on complementary sequence sets and CCC-based beamforming design. Both schemes can obtain a completely smooth beam pattern in each direction, with low complexity and closed-form solution. Furthermore, most complementary sequence sets and code words of the complete complementary codes show a constant modulus, so that the whole beamforming scheme can be efficiently realized only by using the simulation-domain beamforming architecture. The hardware efficiency is effectively improved.

### CROSS-REFERENCE TO RELATED APPLICATIONS

This application claims the benefit of priority from Chinese Patent Application No. CN201811262310.5, filed on Oct. 27, 2018. The content of the aforementioned application, including any intervening amendments thereto, is incorporated herein by reference in its entirety.

### TECHNICAL FIELD

The present invention belongs to the technical field of common signal transmission, and specifically relates to a CS-based omnidirectional beamforming design method.

### BACKGROUND OF THE PRESENT INVENTION

Large-scale antennas are one of the key technologies for commercialization of 5G. With the increase in the scale of antennas, it is tended to use a uniform rectangular array for implementation in order to facilitate productization. For a base station side with a uniform rectangular array, realizing omnidirectional transmission of common signals and cell-level coverage is one of key factors to improve overall network performance.

### SUMMARY OF THE PRESENT INVENTION

An objective of the present invention is to provide a CS-based omnidirectional beamforming design method in a uniform rectangular array.

The CS-based omnidirectional beamforming design method, as provided in the present invention, is divided into two similar and independent design schemes: beamforming design based on complementary sequence sets and CCC-based beamforming design.

The CS-based omnidirectional beamforming design method in a uniform rectangular array, as provided in the present invention, comprises:

a first step of, on a base station side consisting of a uniform rectangular large-size antenna array including M antennas, space-time block coding an incoming data flow to be sent, a matrix used for the space-time block coding having K x N dimensions, specifically:

$$B {=}^{△} [ \begin{matrix}{s}_{1}^{( 1 )} & ⋯ & {s}_{1}^{( N )} \\ ⋮ & ⋱ & ⋮ \\ {s}_{K}^{( 1 )} & ⋯ & {s}_{K}^{( N )}\end{matrix} ] \qquad ( 1 )$$

M=P×Q, where P and Q represent a row and column of the antenna array, as shown in FIG. 1;

a second step of performing beamforming on the obtained space-time block codes by K beamforming vectors W=[w₁, w₂, . . . , w_{K}], the vector being a beamforming matrix having M×K dimensions, to obtain following a signal to be sent:

X=WB [symbol] (2)

where X∈ [symbol] ^{M×N} is a common signal to be broadcasted and sent by the base station side to each user, and each beamforming vector wₖ can be divided into P vectors each corresponding to an antenna in a row of the rectangular array and having a length of Q: wₖ=[w_{k,1}^{T},w_{k,2}^{T}, . . . , w_{k,P}^{T}]^{T}, k=1,2 . . . , K, where w_{k,p}=[w_{k,p1},w_{k,p2}, . . . , w_{k,pQ}]^{T};

a third step of defining a steering vector matrix [A(φ,θ)] in the uniform rectangular array in the first step, and a steering vector a(φ,θ) after vectorization of the uniform rectangular array, specifically:

$$\begin{matrix} {[ A ( ϕ , θ ) ]}_{pq} = {e}^{- j \frac{2 π}{λ} ( p - 1 ) {d}_{y} sin ϕ sin θ - j \frac{2 π}{λ} ( q - 1 ) {d}_{x} sin ϕ cos θ} , \\ for p = 1 , 2 , ⋯ , P ; q = 1 , 2 , ⋯ , Q ; \text{?} & ( 3 ) \\ a ( ϕ , θ ) = vec ( A ( ϕ , θ ) ) \text{?} & ( 4 ) \\ \text{?} \text{indicates text missing or illegible when filed} & \end{matrix}$$

where φ and θ are an angle between a certain emission direction in a space and an x-axis and an angle between the emission direction and a z-axis, respectively, in the uniform rectangular array of FIG. 1; d_{y} and dₓ represent the spacing, on a y-axis and the x-axis, of adjacent antennas in the uniform rectangular array, respectively, as shown in FIG. 1; λ represents the wavelength of a transmitted signal; vec represents the vectorization of the rectangular array; thus the obtained effective array response being:

h_{eff}(φ,θ)=W^{H}a(φ,θ) [symbol] (5)

further in combination with the space-time block codes, according to the reference document [1], the obtained signal to noise ratio (SNR) of a received signal, which has been processed, on a user side being:

$$SNR = {‖ {h}_{eff} ( ϕ , θ ) ‖}^{2} \frac{{E}_{S}}{{σ}^{2}} \qquad ( 6 )$$

where E_{S} represents the energy of the sent signal, σ² represents the energy of noise, and

$$\frac{{E}_{S}}{{σ}^{2}}$$

represents the SNR of the input; and

a fourth step of, in order to obtain a completely smooth beam pattern, designing a beamforming matrix by the following standard:

∥h_{eff}(φ,θ)∥²=∥W^{H}a(φ,θ)²=a(φ,θ)^{H}WW^{H}a(φ,θ)=const [symbol] (7)

wherein, let S [symbol] WW^{H}, the matrix is divided into P×P submatrices, specifically:

$$S = [ \begin{matrix}{S}_{1 , 1} & ⋯ & {S}_{1 , P} \\ ⋮ & ⋱ & ⋮ \\ {S}_{P , 1} & ⋯ & {S}_{P , P}\end{matrix} ] \qquad ( 8 )$$

where S_{i,j}=Σₖ₌₁^{K}w_{k,i}w_{k,j}^{H}∈ [symbol] ^{Q×Q};

in the fourth step, there are following existing sequences to be used to complete the omnidirectional beamforming design:

considering two sequences c₁ and c₂ having a length of L:

c₁=(c_{1.1}, . . . , c_{1.L}), c₁=(c_{1.1}, . . . , c_{2.L}) [symbol] (9)

the aperiodic correlation function R_{c}_{_{1,}}_{c}_{₂} (τ) is defined as follows:

$${R}_{{c}_{1} , {c}_{2}} ( τ ) = \{ \begin{matrix}{\sum }_{j = 1}^{L - τ} {c}_{1 , j} {c}_{2 , j + τ}^{*} , & 0 \leq τ \leq L - 1 \\ {\sum }_{j = 1 - τ}^{L} {c}_{1 , j} {c}_{2 , j + τ}^{*} , & 1 - L \leq τ < 0 \\ 0 , & \vert τ \vert \geq L\end{matrix} \qquad ( 10 )$$

for c, the autocorrelation function is the same as (9), as long as c=c₁=c₂; a sequence set {cₙ}ₙ₌₁^{N} is called a (N,L) complementary sequence set if it meets the following equation:

$${\sum }_{n = 1}^{N} {R}_{{c}_{n}} ( τ ) = E δ ( τ )$$

where δ(τ) is a Kronecker-delta function and E [symbol] Σₙ₌₁^{N}Σₜ₌₁^{L}|c_{n,l}|²;

if M sequence sets consisting of N sequences having a length of L meet the following two equations:

$$\begin{matrix} {\sum }_{n = 1}^{N} {R}_{{c}_{mn}} ( τ ) = E δ ( τ ) , for m = 1 , 2 , ⋯ , M & ( 12 ) \\ {\sum }_{n = 1}^{N} {R}_{{c}_{mn} {c}_{{m}^{′} n}} ( τ ) = 0 , ∀ τ ; 1 \leq m \neq {m}^{′} \leq M . \text{?} \\ \text{?} \text{indicates text missing or illegible when filed} & ( 13 )\end{matrix}$$

then, the M sequence sets are called (M,N,L)—complete complementary codes; now, the found complete complementary codes are required as follows: M≤N, and the common divisor of M and L is the greatest factor of L; the (M,N,L)—complete complementary codes consist of M(N,L) complementary sequence sets meeting the equation (12);

the sequences are expressed, in the form of vectors, by c∈ [symbol] ^{L}, then the equations (10), (11) and (12) are expressed by:

$$\begin{matrix} tr ( {E}_{L}^{- τ} {\sum }_{n = 1}^{N} {c}_{n} {c}_{n}^{H} ) = E δ ( τ ) \text{?} & ( 14 ) \\ tr ( {E}_{L}^{- τ} {\sum }_{n = 1}^{N} {c}_{mn} {c}_{mn}^{H} ) = E δ ( τ ) , for m = 1 , 2 , ⋯ , M & ( 15 ) \\ tr ( {E}_{L}^{- τ} {\sum }_{n = 1}^{N} {c}_{mn} {c}_{{m}^{′} n}^{H} ) = 0 , ∀ τ ; 1 \leq m \neq {m}^{′} \leq M \text{?} & ( 16 ) \\ \text{?} \text{indicates text missing or illegible when filed} & \end{matrix}$$

where E_{L}^{-τ} represents a Toeplitz matrix that is 1 on the (−τ)^{th} auxiliary diagonal and 0 on all other diagonals, where the diagonal is a super-diagonal when −τ is greater than 0 and a sub-diagonal when −τ is less than 0;

in the fourth step, the omnidirectional beamforming matrix needs to meet the following requirements in order to realize omnidirectional coverage:

let the sum of submatrices on the diagonals of the S matrix in the equation (8):

$$\begin{matrix} {S}_{l} {=}^{△} \{ \begin{matrix}{\sum }_{p = 1}^{P - 1} {S}_{p , p + l} , & 0 \leq l \leq P - 1 \\ {\sum }_{p = - \text{?} + 1}^{P - 1} {S}_{p , p + l} & - P + 1 \leq l \leq 0\end{matrix} & ( 17 ) \\ \text{?} \text{indicates text missing or illegible when filed} & \end{matrix}$$

the equation (3) is rewritten by

$$= \frac{{d}_{x}}{λ} sin ϕcosθ and v = \frac{{d}_{y}}{λ} sin ϕsinθ ,$$

and the equation (3) is substituted into the equation (7) to obtain:

$${‖ {W}^{H} a ( ϕ , θ ) ‖}^{2} = {\sum }_{l = - P + 1}^{P - 1} {\sum }_{n = - Q + 1}^{Q - 1} tr ( {E}_{Q}^{- n} {S}_{l} ) {e}^{j \frac{2 π}{Q} nu} {e}^{j \frac{2 π}{Q} tv} \qquad ( 18 )$$

where E_{Q}⁻ⁿ represents a Toeplitz matrix that is 1 on the (−n)^{th} auxiliary diagonal and 0 on all other diagonals, where the diagonal is a super-diagonal when −n is greater than 0 and a sub-diagonal when −n is less than 0; it can be found in the equation (18) that the signal energy obtained in each direction is the two-dimensional Fourier transform of tr(E_{Q}⁻ⁿSₗ), and therefore, if tr(E_{Q}⁻ⁿSₗ) meets the following condition:

tr(E_{Q}⁻ⁿSₗ)=Eδ(n)δ(l) [symbol] (19).

then, the obtained value of ∥W^{H}a(φ,θ)∥² is independent of the direction (θ,φ);

in the fourth step, there are following two beamforming matrix design schemes:

first scheme: beamforming matrix design based on complementary sequence sets

it is assumed that {c₁, c₂, . . . , c_{P}} is a (P,Q) complementary sequence set, then a beamforming matrix having a rank of K=P to realize omnidirectional coverage is designed as follows:

$$W = [ \begin{matrix}{c}_{1} & ⋯ & 0 \\ ⋮ & ⋱ & ⋮ \\ 0 & ⋯ & {c}_{P}\end{matrix} ] \qquad ( 20 )$$

from the equation (20), then:

$$S = {WW}^{H} = [ \begin{matrix}{c}_{1} {c}_{1}^{H} & ⋯ & 0 \\ ⋮ & ⋱ & ⋮ \\ 0 & ⋯ & {c}_{P} {c}_{P}^{H}\end{matrix} ] \qquad ( 21 )$$

it can be known that:

according to the definition of S₁ in the equation (17), Sₗ=0, ∀l≠0;

according to the equation (11) for the property of the complementary sequence set and S₀=Σₚ₌₁^{P}cₚcₚ^{H}, then:

tr(E_{Q}^{τ}S₀)=Eδ(τ) [symbol] (22)

thus, the omnidirectional beamforming matrix based on complementary sequence sets, constructed according to the equation (21), realizes omnidirectional coverage, i.e., meets the equation (19);

second scheme: beamforming matrix design based on complete complementary codes:

it is assumed that {c₁₁, . . . , c_{1K}}, {c₂₁, . . . , c_{2K}}, . . . , {c_{P1}, . . . , c_{PK}} are (P,K,Q)—complete complementary codes, then a beamforming matrix having a rank of K to realize omnidirectional coverage is designed as follows:

$$W = [ \begin{matrix}{c}_{11} & ⋯ & {c}_{1 K} \\ ⋮ & ⋱ & ⋮ \\ {c}_{P1} & ⋯ & {c}_{PK}\end{matrix} ] \qquad ( 23 )$$

from the equation (20) and the equation (8), then:

S_{i,j}=Σₚ₌₁^{P}c_{i,k}c_{j,k}^{H} [symbol] (24)

and according to the equations (15) and (16), then:

tr(E_{Q}^{τ}S_{i,j})=Eδ(τ)(i−j) [symbol] (25)

thus, the CCC-based omnidirectional beamforming design, constructed according to the equation (25), realizes omnidirectional coverage, i.e., meets the equation (19).

The present invention has the following advantages:

(1) two beamforming designs that can, theoretically, completely realize omnidirectional transmission of common signals are obtained, and same array response is found in any point in a space;

(2) both omnidirectional beamforming designs in the present invention are extremely low in complexity and have a closed-form solution, and the implementation is simple without consumption of computing resources;

(3) the non-zero elements in the obtained beamforming matrix show a constant modulus, which may be implemented by the fully-connected RF beamforming structure of FIG. 3 and the partially-connected RF beamforming structure of FIG. 4, and the power efficiency on the RF side can be improved greatly.

### BRIEF DESCRIPTION OF THE DRAWINGS

FIG. 1 is a view of a uniform rectangular array;

FIG. 2 is a view of an omnidirectional transmission system for common signals;

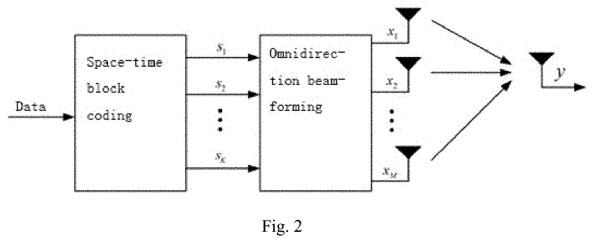

FIG. 3 shows a fully-connected RF beamforming structure;

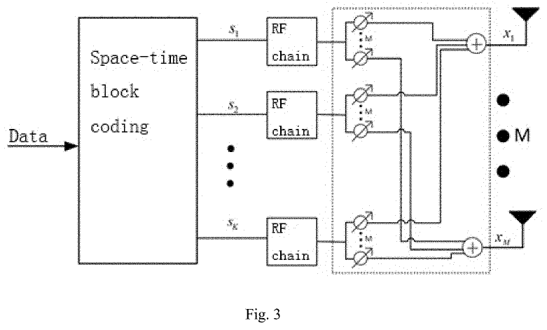

FIG. 4 shows a partially-connected RF beamforming structure;

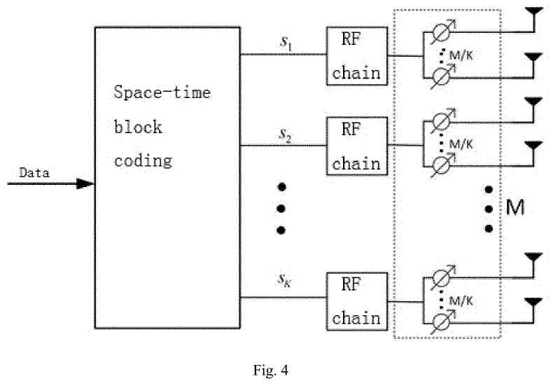

FIG. 5 shows a spatial beam pattern of the beamforming design based on complementary sequence sets; and

FIG. 6 shows the BER performance of the two beamforming designs.

### DETAILED DESCRIPTION OF THE PRESENT INVENTION

The present invention will be further described below by specific embodiments.

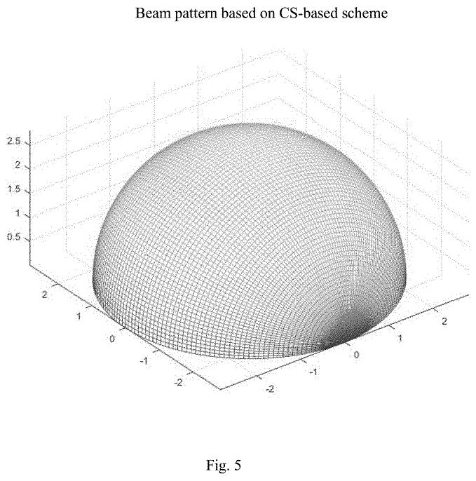

As an embodiment, in the present invention, the beam pattern of the beamforming matrix based on complementary sequence sets in a 8×16 uniform rectangular array is simulated by a computer, as shown in FIG. 5. It can be found that it has the same signal energy distribution in the space. The omnidirectional beam coverage is realized.

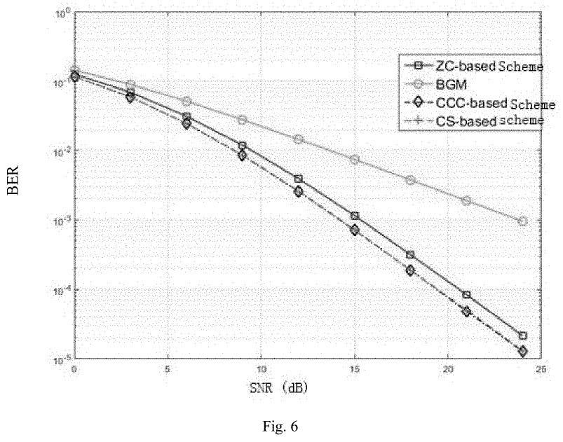

In the present invention, the BER performance of the system is also stimulated in the case where Alamouti codes are used as the space-time block codes. For a 2×16 uniform rectangular array, both beamforming matrices obtained in the equations (20) and (23) have a rank of 2. There are other two comparison methods: ZC-based scheme (two Zadoff-Chu sequences are used to produce a kronecker product to obtain a beamforming matrix) and BGM (broadbeam generation method, with reference to [2]). In this stimulation, 10⁵ Monte Carlo experiments have been carried out. The final BER result is shown in FIG. 6, wherein x-axis represents the magnitude of the SNR, and y-axis is the average of BERs obtained by multiple experiments. It can be found that, at each SNR, both omnidirectional beamforming matrix designs proposed in the present invention have lower BER and faster decreasing trend. Compared with the ZC-based scheme, the schemes of the present invention have a coding gain of about 1 dB; and compared with the BGM, the performance of the schemes of the present invention is significantly improved. For example, when the BER is about 10⁻³, the design schemes of the present invention have a SNR gain of 10 dB compared to the BGM. Therefore, the three schemes of the present invention have high practicability and robustness.

### REFERENCE DOCUMENTS

[1] Ganesan G, Stoica P. Space-time block codes: a maximum SNR approach. IEEE Transactions on Information Theory, vol. 47, no. 4, pp. 1650-1656, May 2001
[2] Qiao, Deli, H. Qian, and G. Y. Li. Broadbeam for Massive MIMO Systems. IEEE Transactions on Signal Processing, vol. 64, no. 9, pp. 2365-2374, May 2016

What is claimed is:

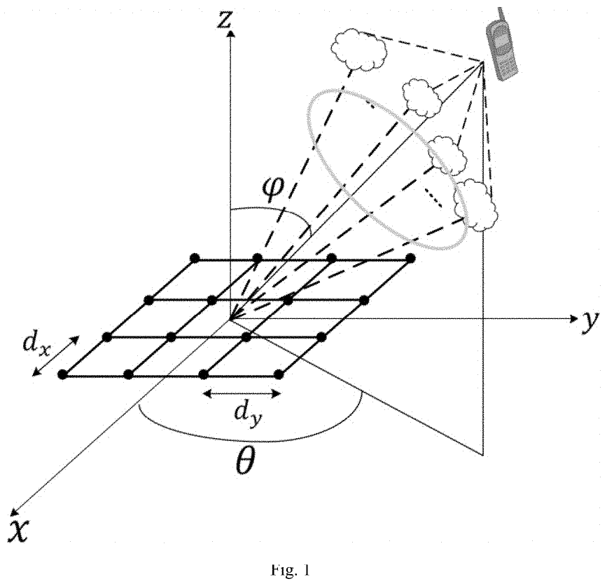

1. A CS-based omnidirectional beamforming design method in a uniform rectangular array, comprising:
a first step of, on a base station side consisting of a uniform rectangular large-size antenna array including M antennas, space-time block coding an incoming data flow to be sent, a matrix B used for the space-time block coding having K×N dimensions, specifically:
$$B {=}^{Δ} [ \begin{matrix}{s}_{1}^{( 1 )} & … & {s}_{1}^{( N )} \\ ⋮ & ⋱ & ⋮ \\ {s}_{K}^{( 1 )} & … & {s}_{K}^{( N )}\end{matrix} ] . \qquad ( 1 )$$
M=P×Q, where P and Q represent a row and column of the antenna array;
a second step of performing beamforming on the obtained space-time block codes by K beamforming vectors W=[w₁, w₂, . . . , w_{K}], the vector being a beamforming matrix having M×K dimensions, to obtain following a signal to be sent:
X=WB [symbol] (2)
where X∈ [symbol] ^{M×N} is a common signal to be broadcasted and sent by the base station side to each user, and each beamforming vector wₖ can be divided into P vectors each corresponding to an antenna in a row of the rectangular array and having a length of Q: wₖ=[w_{k,1}^{T},w_{k,2}^{T}, . . . , w_{k,P}^{T}]^{T}, k=1,2 . . . , K, where w_{k,p}=[w_{k,p1},w_{k,p2}, . . . , w_{k,pQ}]^{T};
a third step of defining a steering vector matrix [A(φ,θ)] in the uniform rectangular array in the first step, and a steering vector a(φ,θ) after vectorization of the uniform rectangular array, specifically:
$$\begin{matrix}{[ A ( ϕ , θ ) ]}_{pq} = {e}^{- j \frac{2 π}{λ} ( p - 1 ) {d}_{y} si n θ - j \frac{2 π}{λ} ( q - 1 ) {d}_{x} si n ϕ co s θ} . \\ for p = 1 , 2 , … , P ; q = 1 , 2 , … , Q ; & ( 3 ) \\ a ( ϕ , θ ) = vec ( A ( ϕ , θ ) ) . & ( 4 )\end{matrix}$$
where φ and θ are an angle between a certain emission direction in a space and an x-axis and an angle between the emission direction and a z-axis, respectively, in the uniform rectangular array of FIG. 1; d_{y} and dₓ represent the spacing, on a y-axis and the x-axis, of adjacent antennas in the uniform rectangular array, respectively; λ represents the wavelength of a transmitted signal; vec represents the vectorization of the rectangular array; thus the obtained effective array response being:
h_{eff}(φ,θ)=W^{H}a(φ,θ) [symbol] (5)
further in combination with the space-time block codes, according to the reference document [1], the obtained signal to noise ratio (SNR) of a received signal, which has been processed, on a user side being:
$$SNR = {‖ {h}_{eff} ( ϕ , θ ) ‖}^{2} \frac{{E}_{S}}{{σ}^{2}} ↵ \qquad ( 6 )$$
where E_{S} represents the energy of the sent signal, σ² presents the energy of noise, and
$$\frac{{E}_{S}}{{σ}^{2}}$$
represents the SNR of the input; and
a fourth step of, in order to obtain a completely smooth beam pattern, designing a beamforming matrix by the following standard:
∥h_{eff}(φ,θ)∥²=∥W^{H}a(φ,θ)²=a(φ,θ)^{H}WW^{H}a(φ,θ)=const [symbol] (7)
where const is a constant that is not zero;
wherein, let S [symbol] WW^{H}, the matrix is divided into P×P submatrices, specifically:
$$S = [ \begin{matrix}{S}_{1 , 1} & … & {S}_{1 , P} \\ ⋮ & ⋱ & ⋮ \\ {S}_{P , 1} & … & {S}_{P , P}\end{matrix} ] \qquad ( 8 )$$
where S_{i,j}=Σₖ₌₁^{K}w_{k,i}w_{k,j}^{H}∈ [symbol] ^{Q×Q};
in the fourth step, there are following existing sequences to be used to complete the omnidirectional beamforming design:
considering two sequences c₁ and c₂ having a length of L:
c₁=(c_{1.1}, . . . , c_{1.L}), c₁=(c_{1.1}, . . . , c_{2.L}) [symbol] (9)
the aperiodic correlation function R_{c}_{_{1,}}_{c}_{₂} (τ) is defined as follows:
$${R}_{{c}_{1} , {c}_{2}} ( τ ) = \{ \begin{matrix}{\sum }_{j = 1}^{L - τ} {c}_{1 , j} {c}_{2 , j + τ}^{*} , & 0 \leq τ \leq L - 1 \\ {\sum }_{j = 1 - τ}^{L} {c}_{1 , j} {c}_{2 , j + τ}^{*} , & 1 - L \leq τ < 0 \\ 0 , & \vert τ \vert \geq L\end{matrix} . \qquad ( 10 )$$
for c, the autocorrelation function is the same as (9), as long as c=c₁=c₂; a sequence set {cₙ}ₙ₌₁^{N} is called a (N,L) complementary sequence set if it meets the following equation:
$${\sum }_{n = 1}^{N} {R}_{{c}_{n}} ( τ ) = E δ ( τ ) \qquad ( 11 )$$
where δ(τ) is a Kronecker-delta function and E [symbol] Σₙ₌₁^{N}Σₜ₌₁^{L}|c_{n,l}|²;
if M sequence sets consisting of N sequences having a length of L meet the following two equations:
$$\begin{matrix}{\sum }_{n = 1}^{N} {R}_{{c}_{mn}} ( τ ) = E δ ( τ ) , for m = 1 , 2 , … , M & ( 12 ) \\ {\sum }_{n = 1}^{N} {R}_{{c}_{mn} {c}_{{m}^{′} n}} ( τ ) = 0 , ∀ τ ; 1 \leq m \neq {m}^{′} \leq M & ( 13 )\end{matrix}$$
then, the M sequence sets are called (M,N,L)—complete complementary codes; now, the found complete complementary codes are required as follows: M≤N, and the common divisor of M and L is the greatest factor of L; the (M,N,L)—complete complementary codes consist of M(N,L) complementary sequence sets meeting the equation (12);
the sequences are expressed, in the form of vectors, by c∈ [symbol] ^{L}, then the equations (10), (11) and (12) are expressed by:
$$\begin{matrix}tr ( {E}_{L}^{- τ} {\sum }_{n = 1}^{N} {c}_{n} {c}_{n}^{H} ) = E δ ( τ ) & ( 14 ) \\ tr ( {E}_{L}^{- τ} {\sum }_{n = 1}^{N} {c}_{mn} {c}_{mn}^{H} ) = E δ ( τ ) , for m = 1 , 2 , … , M & ( 15 ) \\ tr ( {E}_{L}^{- τ} {\sum }_{n = 1}^{N} {c}_{mn} {c}_{{m}^{′} n}^{H} ) = 0 , ∀ τ ; 1 \leq m \neq {m}^{′} \leq M & ( 16 )\end{matrix}$$
where E_{L}^{-τ} represents a Toeplitz matrix that is 1 on the (−τ)^{th} auxiliary diagonal and 0 on all other diagonals, where the diagonal is a super-diagonal when −τ is greater than 0 and a sub-diagonal when −τ is less than 0;
in the fourth step, the omnidirectional beamforming matrix needs to meet the following requirements in order to realize omnidirectional coverage:
let the sum of submatrices on the diagonals of the S matrix in the equation (8):
$${S}_{l} {=}^{Δ} \{ \begin{matrix}{\sum }_{p = 1}^{P - l} {S}_{p , p + l} , & 0 \leq l \leq P - 1 \\ {\sum }_{p = - l + 1}^{P} {S}_{p , p + l} , & - P + 1 \leq l \leq 0\end{matrix} \qquad ( 17 )$$
the equation (3) is rewritten by
$$= \frac{{d}_{x}}{λ} sin ϕ cos θ and v = \frac{{d}_{y}}{λ} sin ϕ sin θ ,$$
and the equation (3) is substituted into the equation (7) to obtain:
$${‖ {W}^{H} a ( ϕ , θ ) ‖}^{2} = {\sum }_{l = - P + 1}^{P - 1} {\sum }_{n = - Q + 1}^{Q - 1} tr ( {E}_{Q}^{- n} {S}_{l} ) {e}^{j \frac{2 π}{Q} n u} {e}^{j \frac{2 π}{P} lv} \qquad ( 18 )$$
where E_{Q}⁻ⁿ represents a Toeplitz matrix that is 1 on the (−n)^{th} auxiliary diagonal and 0 on all other diagonals, where the diagonal is a super-diagonal when −n is greater than 0 and a sub-diagonal when −n is less than 0; it can be found in the equation (18) that the signal energy obtained in each direction is the two-dimensional Fourier transform of tr(E_{Q}⁻ⁿSₗ), and therefore, if tr(E_{Q}⁻ⁿSₗ) meets the following condition:
tr(E_{Q}⁻ⁿSₗ)=Eδ(n)δ(l) [symbol] (19).
then, the obtained value of ∥W^{H}a(φ,θ)∥² is independent of the direction (θ,φ);
in the fourth step, there are following two beamforming matrix design schemes:
first solution: beamforming matrix design based on complementary sequence sets
it is assumed that {c₁, c₂, . . . , c_{P}} is a (P,Q) complementary sequence set, then a beamforming matrix having a rank of K=P to realize omnidirectional coverage is designed as follows:
$$W = [ \begin{matrix}{c}_{1} & … & 0 \\ ⋮ & ⋱ & ⋮ \\ 0 & … & {c}_{P}\end{matrix} ] . \qquad ( 20 )$$
from the equation (20), then:
$$S = {WW}^{H} = [ \begin{matrix}{c}_{1} {c}_{1}^{H} & … & 0 \\ ⋮ & ⋱ & ⋮ \\ 0 & … & {c}_{P} {c}_{P}^{H}\end{matrix} ] . \qquad ( 21 )$$
it can be known that:
according to the definition of S₁ in the equation (17), Sₗ=0, ∀l≠0;
according to the equation (11) for the property of the complementary sequence set and S₀=Σₚ₌₁^{P}cₚcₚ^{H}, then:
tr(E_{Q}^{τ}S₀)=Eδ(τ) [symbol] (22)
thus, the omnidirectional beamforming matrix based on complementary sequence sets, constructed according to the equation (21), realizes omnidirectional coverage, i.e., meets the equation (19);
second solution: beamforming matrix design based on complete complementary codes:
it is assumed that {c₁₁, . . . , c_{1K}}, {c₂₁, . . . , c_{2K}}, . . . , {c_{P1}, . . . , c_{PK}} are (P,K,Q)—complete complementary codes, then a beamforming matrix having a rank of K to realize omnidirectional coverage is designed as follows:
$$W = [ \begin{matrix}{c}_{11} & … & {0}_{1 K} \\ ⋮ & ⋱ & ⋮ \\ {0}_{P 1} & … & {c}_{PK}\end{matrix} ] \qquad ( 23 )$$
from the equation (20) and the equation (8), then:
S_{i,j}=Σₚ₌₁^{P}c_{i,k}c_{j,k}^{H} [symbol] (24)
and according to the equations (15) and (16), then:
tr(E_{Q}^{τ}S_{i,j})=Eδ(τ)(i−j) [symbol] (25)
thus, the CCC-based omnidirectional beamforming design, constructed according to the equation (25), realizes omnidirectional coverage, i.e., meets the equation (19).
